(19) United States
(12) Patent Application Publication
(10) Pub. No.: US 2006/0235710 A1
(43) Pub. Date: Oct. 19, 2006

(54) System and method for tracking items

(75) Inventors: David Hodess, Los Angeles, CA (US); Steve Brown, Los Angeles, CA (US); Terri J. Luke, Los Angeles, CA (US)

Correspondence Address: MORRISON & FOERSTER, LLP, 555 WEST FIFTH STREET, SUITE 3500, LOS ANGELES, CA, 90013-1024, US

(73) Assignee: GAMEFLY, INC., Los Angeles, CA (US)

(21) Appl. No.: 11/110,514

(22) Filed: Apr. 19, 2005

(51) Int. Cl. G06Q 99/00; G06Q 30/00

(52) U.S. Cl. 705/1; 705/26

(57) ABSTRACT

The preferred embodiment of the present invention is directed to a method of operating an online rental program by a rental retailer. Specifically, rental items are delivered to a subscriber via an independent mail carrier such as the United States Postal Service, wherein a rental item is sent to a subscriber along with a return mailing envelope that includes a return mailing label for mailing the rental back to the rental retailer. In accordance with the preferred embodiment, the return mailing label includes a mailing code that can be scanned by the independent mail carrier for purposes of informing the rental retailer, upon receiving the return envelope at a receiving facility of the independent mail carrier, that a rental item has been received and is being delivered back to the rental retailer. Once the rental retailer receives confirmation from the independent mail carrier that a rental item is being mailed back from a subscriber, the rental retailer sends out a next rental item to the subscriber.

### FIELD OF INVENTION

The preferred embodiments of the present invention are directed to a system and method for tracking and managing items in circulation, such as DVDs that are circulated via a mail carrier between the warehouse of a DVD rental merchant (e.g., an on-line DVD rental store) and a renting customer.

### DESCRIPTION OF RELATED ARTS

A. Online Subscription Rental Services

Many video or game rental retailers, such as Netflix Inc. or Blockbusters Inc., offer in-home video or game rental services to consumers (hereinafter referred to as “rental subscribers” or “subscribers”) via the Internet (see, e.g., www.netflix.com or www.blockbuster.com; see also www.gamefly.com). Conventionally, a rental subscriber first establishes an account with the retailer by providing a mailing address, credit card information, etc.; this is typically done through the retailer's website. The subscriber is then asked to make a selection of movies or video games that the subscriber would like to rent; often times, the selections are confirmed by placing the titles of the selections into a “queue” assigned to that subscriber, who can view the queue and later edit the queue by adding or deleting selections from the queue.

Once a selection of movie or game titles are made, the retailer mails the titles (such as a movie on a DVD disk) to the subscriber's mailing address. Depending upon the specific rental program and the account that is established by the subscriber, the subscriber may keep, for instance, two rental items at any given time. Retailer websites, such as www.gamefly.com, will indicate on the subscriber's queue as to which items are rented out to the subscriber at any given time. FIG. 1 shows a screen shot of a subscriber queue indicating items selected by the subscriber for rental, and items that are rented out to the subscriber at that time.

Typically, the retailer provides to the subscriber self-addressed return envelopes for mailing back the rental items. U.S. patent application Ser. No. 10/681,077, titled “System and Apparatus for Protecting Digital Media,” the entirety of which is hereby incorporated by reference, discloses a system for sending a digital media (such as a DVD disk) to a rental subscriber, wherein the system includes a resealable envelope having a return mailing label for mailing the digital media to the rental retailer. Upon receiving the returned rental items, the retailer will update the subscriber account to reflect the return of the rental items, and send out to the subscriber new rental items that are listed on the subscriber's queue. Of course, if the subscriber returns only one of the two rental items, then the retailer will mail out only one new rental item upon receiving the one returned rental item.

The inventory of rental items is typically stored in one or more warehouse facilities. For instance, at the time of this patent application preparation, Gamefly Inc. operates a centralized warehouse that is based in Los Angeles, Calif. Because the items are typically delivered via U.S. mail operated by the United States Postal Service (“USPS”), subscribers with mailing addresses that are relatively farther from the warehouse(s) will typically receive their rental items later than the subscribers with mailing addresses relatively closer to the warehouse(s). Similarly, return rental items from distant subscribers take longer to reach the retailer, resulting in a longer delay for the distant subscriber to receive the next rental item on the rental queue. For example, while it may take only a day for U.S. mail to be delivered between Los Angeles and San Diego, it may take up to four days for mail to be delivered between Los Angeles and New York. Hence, a subscriber who lives in San Diego may receive a new rental item only two days after mailing the return rental item, while a subscriber who lives in New York may not receive a new rental item until a week after mailing the return rental item.

As a result of the delay for subscribers who have a mailing address that is physically farther from the warehouse, these subscribers may cancel their subscription with the retailer, opting for a different retailer with a warehouse that is located closer to the subscriber or can otherwise provides a faster turnaround service. This creates a competitive disadvantage for rental retailers who do not operate warehouse facilities throughout the United States. Accordingly, in the instance of retailers such as Gamefly Inc., which operates a centralized warehouse in Los Angeles, there is a need to provide an improved delivery system to shorten the turn-around time for new rental items to reach the distant subscribers.

B. Overview of USPS Confirm Service

The USPS Confirm Service is a service provided by the USPS that allows mass mailers to uniquely identify and track outbound and inbound mail pieces as they are processed through the USPS system. The Confirm Service implements the use of certain mailing barcode on a mailing label (e.g., the USPS Postal Alpha Numeric Encoding Technique (“PLANET”) code and the USPS Postal Numeric Encoding Technique (“POSTNET”) code) that can be scanned at a processing facility of the USPS. The POSTNET codes is used to encode routing information such as the zip code of the destination address of the mail piece, while the PLANET code is used exclusively by the USPS Confirm Service to identify the mail pieces uniquely.

As shown in FIGS. 2a through 2d, mailing barcodes can be used and placed in various different configurations. FIG. 2a shows a regular mailing label that does not include any mailing barcodes that can be scanned. FIG. 2b shows a mailing label having a destination address block encoded with a POSTNET code at the bottom of the label. FIG. 2c shows a mailing label having both a POSTNET code and a PLANET code (the PLANET code being on top of the address and the POSTNET code being below the address). Finally, FIG. 2d shows an example of a mailing label having only the PLANET code on top. The U.S. Postal Service Publication No. 197, “Confirm User Guide,” dated September of 2004, the entirety of which is hereby incorporated for background purposes, provides detailed discussions pertaining to the various operating aspects of the USPS Confirm Service, as well as the proper use of PLANET and POSTNET codes.

Both the PLANET code as well as the POSTNET code can be scanned using barcode scanners. The scanned data can be stored and/or transmitted electronically to be used for, in the case of PLANET codes, tracking individual mailing pieces or, in the case of both PLANET and POSTNET codes, as feedback information for controlling the mailing process generally. Merchants who mail out large quantities of mail pieces can take advantage of the USPS Confirm Service to track and control the mailing process of their mail pieces, especially if the mail pieces include self-addressed return envelops for replies.

For instance, each month a credit card issuer such as Citibank or Bank of American may send thousands of mail pieces each month to solicit applications for credit cards. Mass mailers such as the credit card issuers can use the scanned information from the different receiving and/or sorting facilities as feedback information to track both the outbound mail pieces as well as the reply traffic, and use that information to anticipate and streamline the internal mailing process preparations. U.S. Pat. No. 6,557,755, which is hereby incorporated by reference in its entirety for background purposes, discusses and illustrates some of the methods that use information scanned from the USPS mailing barcodes to control mailing processes.

Other independent shipping service providers, such as UPS or FedEx, provide comprehensive tracking services that can accomplish the same objectives as the USPS Confirm Service. More specifically, the full tracking service provided by shippers such as UPS and FedEx scans the barcode(s) of an item each time the item exchanges hands (e.g., pick up scan, facility scan, arrival scan, etc.). Although full tracking systems can provide real-time tracking information of a given package or letter, such a system is generally more expensive to implement and the cost is frequently passed on to the consumers. As a result, such a system may not be cost efficient for merchants who ship many items on a daily basis to subscribers who may not be willing to pay the extra shipping charges.

### SUMMARY OF THE INVENTION

In an effort to improve subscriber loyalty, there exists a need for online rental retailers to provide a faster turnaround time frame for delivering to a subscriber a new rental item once the subscriber returns an outstanding rental item, without adding substantial cost to the existing process.

It is an object of the present invention to improve subscriber experience in rental turnaround time as well as optimize the return process of a retail rental operator by implementing a faster and cost efficient return confirmation service. Specifically, in connection with an on-line rental program by which subscribers receive and return rental items via an independent shipping service provider (e.g., the USPS), the return rental items are scanned at a receiving facility of the shipping provider that is located in close proximity to the a subscriber's mailing address.

In accordance with the preferred embodiment, after a return rental item is collected at a shipping location, such the USPS mailbox of a subscriber, the PLANET barcode of the item is initially scanned at a receiving facility (e.g., the local USPS office) before further delivering the item to the rental retailer. The scanned information is then transmitted electronically to the rental retailer, who promptly processes the information to update the subscriber account so as to reflect the rental item as having been mailed for return. Shortly thereafter, new rental item(s) are sent out to the subscriber, preferably before the return rental item actually reaches the warehouse of the rental retailer.

Once the return rental items arrive at the rental retailer warehouse, the return rental item is scanned again at the warehouse, or otherwise inspected manually, to confirm receipt of the item itself before further updating the subscriber account to confirm receipt of the return rental item. The present invention provides the advantage of reducing the amount of time it takes for a subscriber to receive a new rental item after the return rental item is mailed.

### BRIEF DESCRIPTION OF THE DRAWINGS

FIG. 1 is a graphical illustration of a sample subscriber queue from an on-line rental retailer;

FIGS. 2a-2d illustrate different types of mailing labels that can currently be used with the United States Postal Service;

FIG. 3 is a flow chart of a rental item return process in accordance with the preferred embodiment of the present invention;

FIG. 4a illustrates a sample destination mailing label in accordance with the preferred embodiment of the present invention;

FIG. 4b illustrates a sample origin (return) mailing label in accordance with the preferred embodiment of the present invention;

FIG. 5a is a graphical illustration of the digit assignment for a 14-bit destination USPS PLANET code;

FIG. 5b is a graphical illustration of the digit assignment for a 14-bit origin USPS PLANET code; and

FIG. 6 is a graphical illustration of a sample subscriber queue from an on-line rental retailer who applies the preferred embodiment of the present invention.

### DETAILED DESCRIPTION OF THE PREFERRED EMBODIMENTS

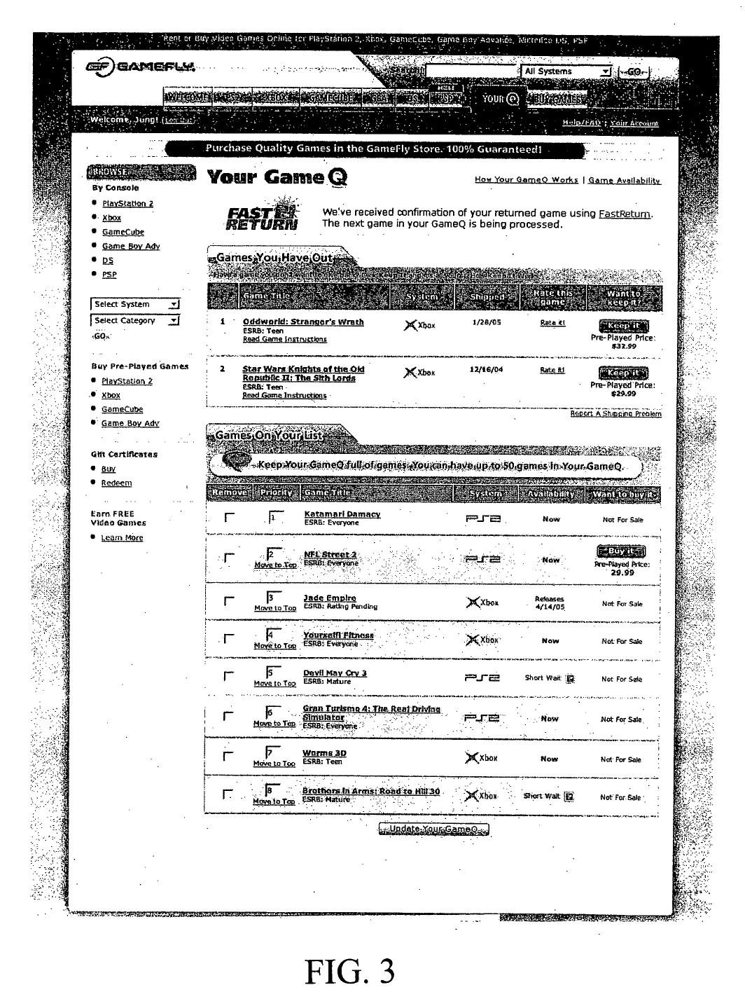

Detailed description of the preferred embodiments will now be described below with references to FIGS. 3-6.

As illustrated in FIG. 3, in accordance with the preferred embodiment of the present invention, a rental retailer, such as Gamefly, Inc., looks up a subscriber's queue to determine what items are desired to be rented by the subscriber (note that FIG. 3 shows a screen shot of what a customer may see while accessing his or her account from the Internet; in practice, the rental retailer may actually access the data from directly from the database to retrieve the same information without the need to access such a graphical interface). The user may list video games such as Halo: Combat Evolved as an item desired to be rented. Upon looking up the items to be rented, the items are retrieved from a warehouse facility of the retail renter and placed into a mailing package such as an envelope to be sent to the subscriber. In accordance with the preferred embodiment, a destination address mailing label for mailing the rental item to the subscriber is generated. The destination address mailing label indicating the name and the mailing address of the subscriber, along with a destination mail barcode that is placed in proximity to the name and address of the subscriber.

In addition to generating a destination address mailing label, a return address mailing label is generated and affixed to a return envelope to be mailed with the rental item. The return envelope is to be used by the subscriber to mail back the rental item to the rental retailer once the subscriber is finished using the rental item (e.g., after the subscriber defeats the covenant forces in Halo: Combat Evolved). Again, U.S. patent application Ser. No. 10/681,077 titled “System and Apparatus for Protecting Digital Media,” the entirety of which was incorporated above by reference, discloses an embodiment of a system for sending a digital media (such as a DVD disk) to a rental subscriber, wherein the system includes a resealable envelope having a return mailing label for mailing the digital media to the rental retailer.

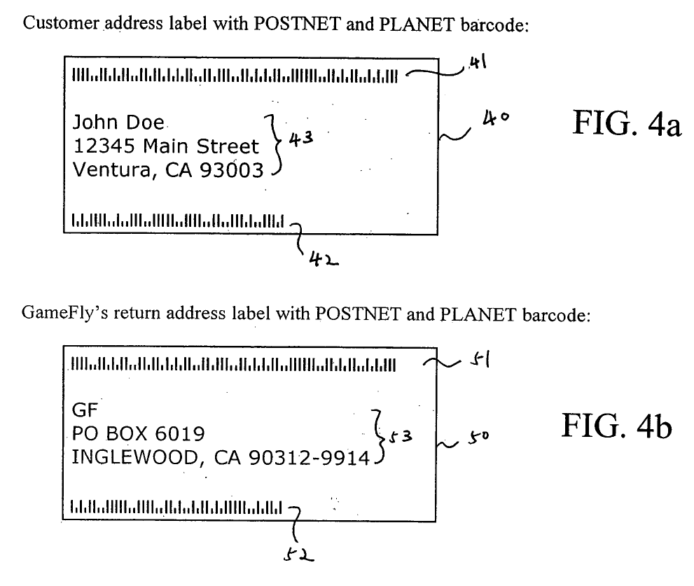

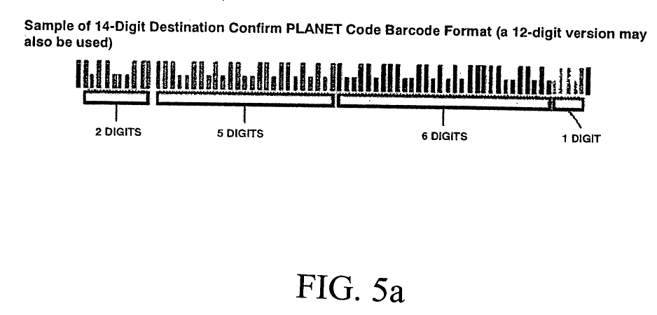

FIG. 4a illustrates a destination address mailing label for mailing a rental item to a subscriber in accordance with the preferred embodiment of the present invention. Specifically, a destination mailing label 40 includes the name and address of a subscriber 43, a 14-bit destination PLANET code 41, and a destination POSTNET code 42. The POSTNET code 42 encodes routing information for delivering the mail piece to the subscriber, while the PLANET code 41 encodes various information for facilitating and tracking the mailing of the mail piece.

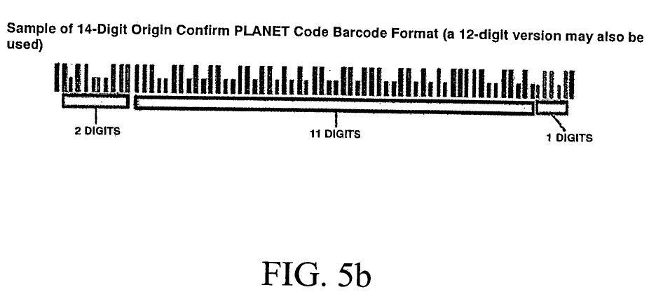

As shown in FIG. 5a, each digit of the 14-bit destination PLANET code is assigned in accordance with the relative position to one another. In particular, the first two digits of the 14-bit destination PLANET code designate the service type of the mail piece (e.g., first class mail letters, periodical letters, etc.). The following five digits are assigned as a unique identification code to the mailer using the USPS Confirm Service (e.g., Netflix, Block Buster, Gamefly, etc.). The next six digits are made available for the mailer's own use; in accordance with the preferred embodiment, the six digits are used for randomly assigning a unique number to a particular rental transaction, wherein the unique number is stored in the rental retailer's database for reference look up purposes (these six digits are hereinafter referred to as “the assignable six digits of the destination PLANET code”). Finally, the last digit of the 14-bit destination PLANET code is a check sum digit for detecting scanning errors.

It is noted that while FIG. 5a illustrates a sample 14-bit destination PLANET code, a 12-bit version of the code may also be used. Indeed, the scope of the present invention is not limited to the use of the USPS PLANET codes, but the use of any scan code that allows a mail carrier to uniquely identify the mailer of a mail piece, as well as allows the mailer to uniquely identify the mail piece as corresponding to a particular transaction.

FIG. 4b illustrates a sample return mailing label 50 that includes the name and address of the rental retailer (e.g., Gamefly (or GF)) 53, a 14-bit origin PLANET code 51, and an origin POSTNET code 52 for routing the return mail piece to the rental retailer. FIG. 5b is a graphical illustration of the digit assignment for a 14-bit origin PLANET code. Specifically, similar to the destination PLANET code, the first two digits are dedicated to indicating the type of service to be used. The next eleven digits are dedicated to be used by the mailer (e.g., rental retailer), and the last digit is used as a check sum digit (the eleven digits are hereinafter referred to as “the assignable eleven digits of the origin PLANET code”)

In accordance with the preferred embodiment of the present invention, for each rental transaction the assignable six digits of the destination PLANET code and the assignable eleven digits of the origin PLANET code are randomly generated and assigned to a particular rental transaction. Preferably, for a given rental transaction, the assignable six digits of the destination PLANET code and the assignable eleven digits of the origin PLANET code are stored in a database as corresponding codes of the same transaction. Preferably, a particular rental transaction stored in a database is retrievable by looking up either the assigned six mailer digits in the destination PLANET code or the assigned eleven mailer digits in the origin PLANET code.

Also in accordance with the preferred embodiment, the assignable six digits of the destination PLANET code, once generated for a particular rental transaction, will be stored in a database such that the same randomly generated code will not be used for another rental transaction for a minimum period of time, such as 30 day. Similarly, the generated assignable eleven digits of the origin PLANET code should not used again for a longer minimum period of time, such as a year. The origin PLANET code should have a longer expiration date since it is difficult to predict how long a subscriber may keep the rental item before mailing the item back to the rental retailer.

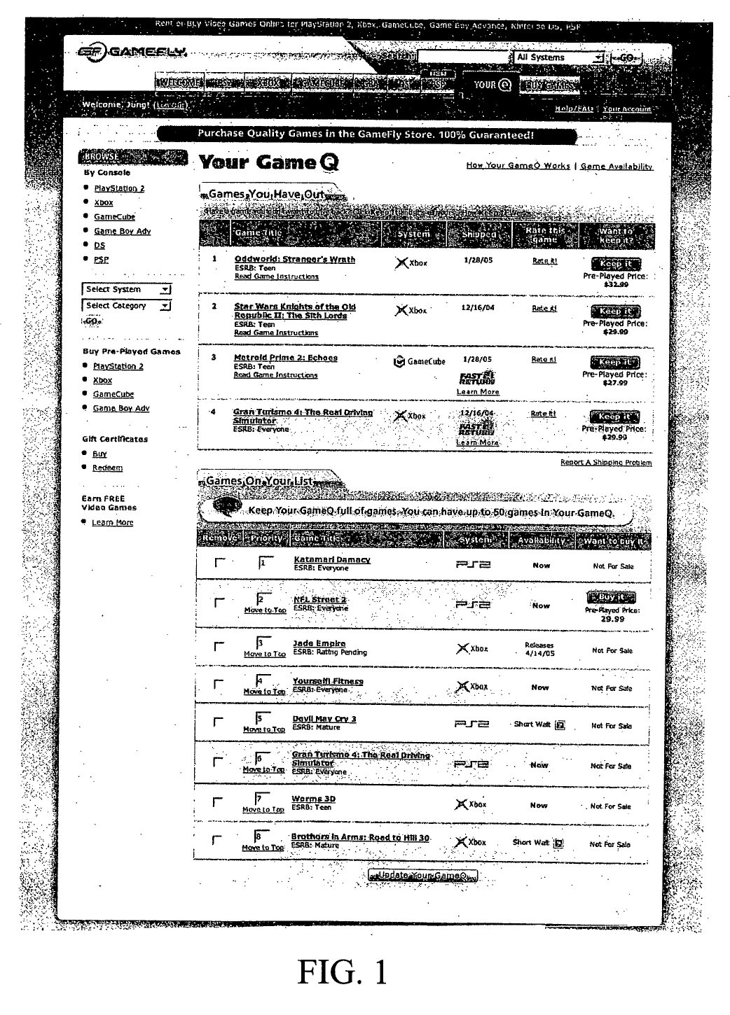

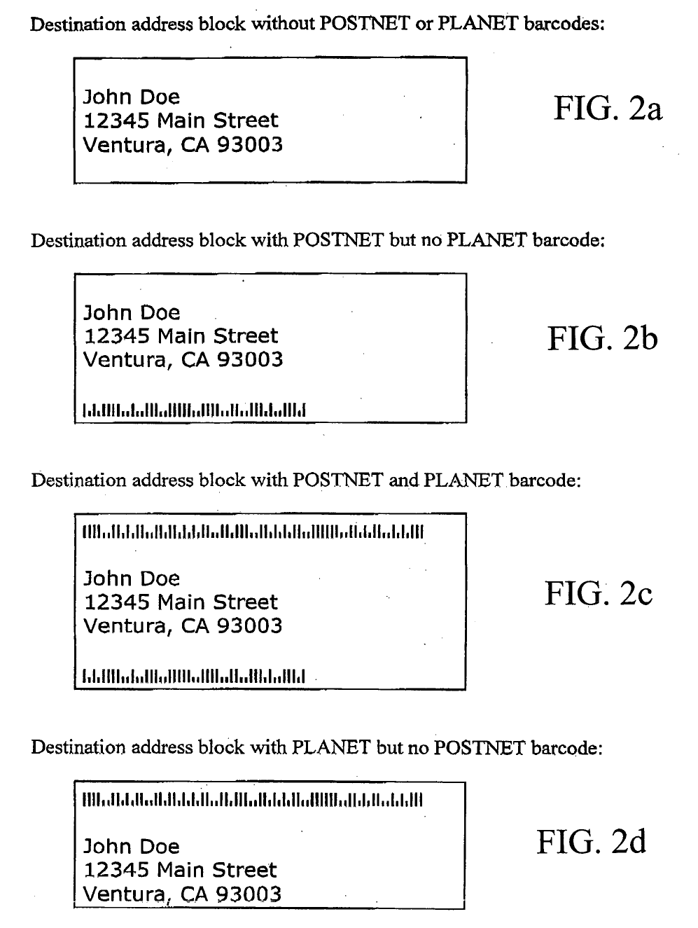

Once the destination mailing label 40 and the return mailing label 50 are generated, they are affixed to the outbound envelope as well as the return envelope, all of which are sent to the subscriber along with the rental item contained therein. In accordance with the preferred embodiment, the rental retailer mass mails various rental items to various subscribers each day. At the mail carrier's receiving facility nearest to the rental retailer (e.g., the local USPS receiving office), the mail pieces are processed during which the destination mailing labels are scanned. At the same time, the rental retailer updates the various subscriber queues to indicate the items as being shipped. In accordance with the preferred embodiment, the rental queue for a subscriber indicates the dates on which the various items were shipped from the rental retailer to the subscriber (see FIG. 1).

In accordance with the preferred embodiment, once the destination mailing label of the outbound rental item is scanned at the initial receiving facility, the rental item is routed to the subscriber by the mail carrier. The destination label is preferably scanned at additional receiving facilities in between the initial receiving facility and the final processing facility before reaching the subscriber so as to produce an electronic tracking record of the rental item. The tracking record is preferably made available to the rental retailer for purposes of tracking the rental item as it reaches the subscriber, and to be used as data for tracking any items that a subscriber may later claim was never received.

More specifically, as discussed above and in accordance with the preferred embodiment, the USPS Confirm Service PLANET code on the destination mailing label includes a section (five digits in instances where the 14-bit version of the PLANET code is used) that uniquely identifies the rental merchant. Therefore, in accordance with the preferred embodiment wherein multiple merchants are using the USPS Confirm Service concurrently, scanned electronic data for all destination mailing labels having a PLANET code can be organized and made available to the appropriate merchants.

In accordance with the preferred embodiment, once the subscriber is finished with the use of the rental item (e.g., finished watching the movie or playing the video game), the subscriber then places the rental item into the provided return envelope with the return mailing label, and drops off the return rental item at the nearest USPS receiving facility (e.g., the local USPS office) or the nearest USPS collection location (e.g., a USPS mailbox). Once the return rental item is collected by the USPS, the return mailing label is scanned at the initial receiving facility. The scanned information is preferably made immediately available to the merchant for further processing. Unlike the destination PLANET code, the origin PLANET code does not include a unique merchant identifier. Hence, the POSTNET code on the return mailing label also needs to be scanned at the same time. That is, although the origin PLANET code does not uniquely identify a merchant, the POSTNET code on the return mailing label uniquely identifies a mailing address belonging to that of the merchant. Accordingly, for all of the origin PLANET codes scanned at a USPS facility to which there exists a corresponding POSTNET code on the mailing label, the scanned information is organized in accordance with the POSTNET code, which is treated as a unique merchant identifier.

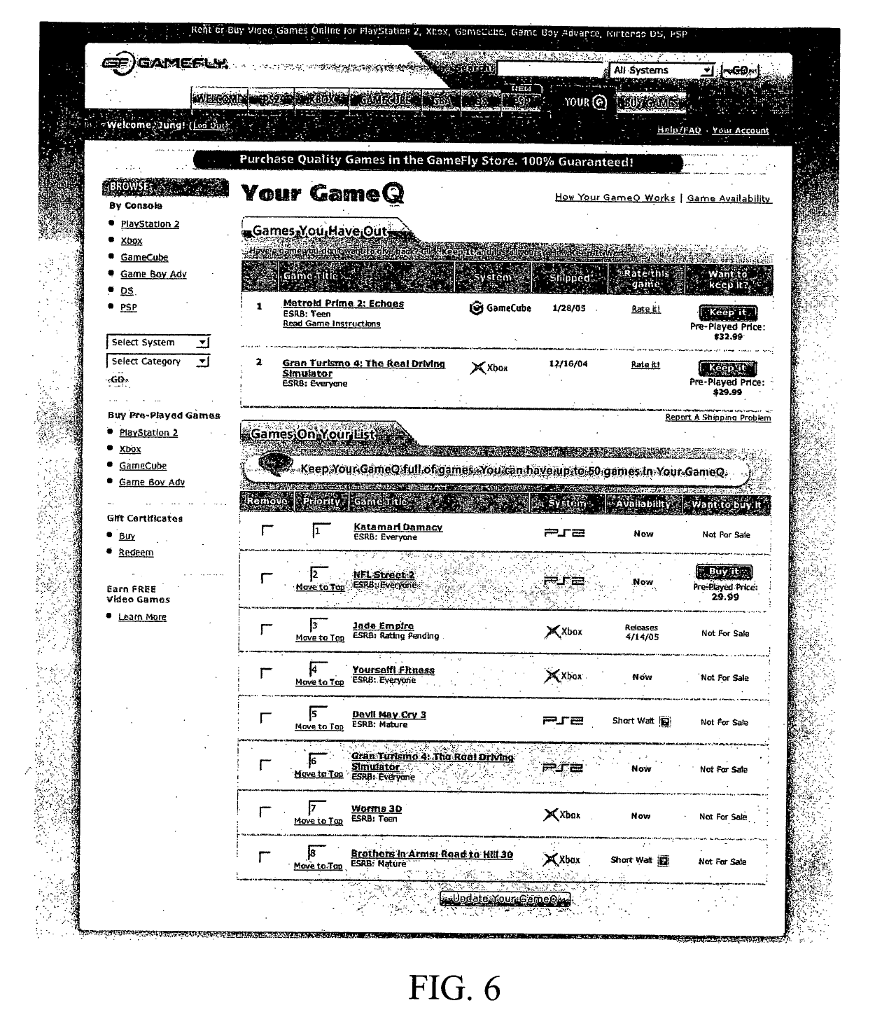

In accordance with the preferred embodiment, a rental retailer on a periodic basis (e.g., daily) will check the electronic data made available to it by the USPS to retrieve a list of origin PLANET codes that have been scanned by the USPS at a receiving facility. Using the assignable eleven digits of the origin PLANET codes, a corresponding list of rental transactions is compiled. The rental items associated with the rental transactions on this compiled list is presumed to have been mailed back to the rental retailer by the subscribers. In accordance with the preferred embodiment, the rental retailer updates the rental queue of the various subscribers who, according to the list of rental transactions retrieved from the USPS, have mailed back rental items. Specifically, the rental queues are updated to indicate that the rental items have been processed and are in route to being returned. FIG. 6 illustrate a screen shot of a rental queue of a subscriber who has returned two rental items that have been scanned by a USPS receiving facility and are identified on the rental queue as being returned via “FastReturn.”

In accordance with the preferred embodiment, upon retrieving a rental transaction from the USPS indicating that a rental item has been mailed back by a subscriber, the next rental item listed on the subscriber's rental queue is promptly mailed to the subscriber even though the return rental item may have not yet have been delivered to the rental retailer or a warehouse facility of the rental retailer. By mailing out the next rental item before the return rental item is actually received, the rental retailer is able to reduce the turnaround time for the subscriber to receive the next rental item after the return rental item is mailed.

Once a return rental item (or at least the mail piece purportedly to carry the rental item) is physically received by the rental retailer, the rental retailer verifies that the rental item is actually received and updates the rental queue of the subscriber to indicate that the return rental item has been actually received physically by the rental retailer.

It should be noted that the present invention may be embodied in forms other than the preferred embodiments described above without departing from the spirit or essential characteristics thereof. The specification contained herein provides sufficient disclosure for one skilled in the art to implement the various embodiments of the present invention, including the preferred embodiment, which should be considered in all aspect as illustrative and not restrictive; all changes or alternatives that fall within the meaning and range or equivalency of the claim are intended to be embraced within.

What we claim:

1. A method of operating an online subscription-based rental service by a rental retailer, said method comprising the steps of:
signing up a subscriber to a monthly subscription rental service, whereby the subscriber may rent and keep a minimum number of rental items per a predetermined period of time;
providing, via the Internet, a rental queue graphical interface to said subscriber by which the subscriber may provide a list of rental items desired to be rented by the subscriber;
sending to the subscriber, via an independent mail carrier, at least one rental item listed by the subscriber;
retrieving, from said independent mail carrier, confirmation that said at least one rental item has been received by the mail carrier from the subscriber; and
sending to the subscriber another rental item listed by the subscriber.

2. The method of claim 1, further comprising the steps of:
generating a destination mailing label, wherein said destination mailing label includes a name and a mailing address of the subscriber; and
generating an origin mailing label, wherein said origin mailing label includes a name and a mailing address of the rental retailer,
wherein said origin mailing label further includes a unique identification for identifying one of a rental transaction associated with the rental of said at least one rental item and said at least one rental item.

3. The method according to claim 2, wherein said destination mailing label further includes another unique identification for identifying one of a rental transaction associated with the rental of said at least one rental item and said at least one rental item.

4. The method according to claim 3, wherein said unique identification and said another unique identification are the same.

5. The method according to claim 2,
wherein said destination mailing label includes a United States Postal Service destination PLANET code and a United States Postal Service POSTNET code, and
wherein said origin mailing label includes a United States Postal Service origin PLANET code and a United States Postal Service POSTNET code, said unique identification being encoded within said United States Postal Service origin PLANET code.

6. The method of claim 1, wherein said independent mail carrier is the United States Postal Service.
